(19) United States
(12) Patent Application Publication
(10) Pub. No.: US 2005/0151382 A1
(43) Pub. Date: Jul. 14, 2005

(54) Article of manufacture for securing a window in a partial open position

(76) Inventor: David James Barber, Saugerties, NY (US)

Correspondence Address: David James Barber, 22 Dave Elliott Rd, Saugerties, NY, 12477, US

(21) Appl. No.: 11/030,610

(22) Filed: Jan. 6, 2005

Related U.S. Application Data
(60) Provisional application No. 60/535,573, filed on Jan. 9, 2004.

(51) Int. Cl. E05C 17/04

(52) U.S. Cl. 292/288

(57) ABSTRACT

An article of manufacture for securing a window in a partial open position with a flat rigid strip of material having a rectangular vertical body with an upper and lower portion. A preferred embodiment includes a generally U-shaped lower portion extending in a first direction from the vertical body, and a generally right triangle shaped upper portion of which the back of the right triangle shape is parallel to the vertical body and the base of the right triangle shape is perpendicular to and extending in a second and opposite direction from the vertical body. The back of the right triangle shape is fastened to the vertical body for added strength and a suction cup or other device is attached to the window side of the upper portion of the vertical body to keep it in a vertical position when the window is closed.

### CROSS REFERENCE TO RELATED APPLICATIONS

This application is based on provisional application Ser. No. 60/535,573, filed on Jan. 9,2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of security and more specifically to an article of manufacture for securing a window in a partial open position.

This invention relates to a device for securing a window in a partially open position and not allowing it to be opened further. More specifically, a window stopping device which allows a window to be opened only a predetermined amount therefore preventing ingress or in the case of small children or pets, egress.

The prior art of this type in considerable as exemplified by U.S. Pat. Nos. 5,125,699; 4,927,198; 5,575,116; 4,825,595 and 4,005,889. These prior attempts all accomplish their purpose but they are complicated and may require the use of tools to install,they may also require the removal and replacement of window sashes or have portions of the device exposed to the outside increasing the likelihood of tampering by a potential intruder. Further, when installing these devices, marring and damage to the window sash is likely. The current invention is a simple device that will work on almost any window. It is easy to install and remove by the average person and is easily portable.

### BRIEF SUMMARY OF THE INVENTION

The primary object of the invention is to provide a device which will easier secure a window in the partial open position.

Another object of the invention is to provide a device to secure a partially open window without the use of tools.

Another object of the invention is to provide a device to secure a partially open window that will not mar the windows sash, frame or surface.

A further object of the invention is to provide a device to secure a partially open window that is easily portable.

Yet another object of the invention is to provide a device to secure a partially open window which is easier to install and remove.

Still yet another object of the invention is to provide a device to secure a partially open window which is more difficult to tamper with when the window is open.

Another object of the invention is to provide a device to secure a window in the partially open position that is less costly to produce.

Another object of the invention is to provide a device to secure a window in the partially open position which is more secure.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for securing a window in a partial open position comprising: a flat rigid strip of material having a rectangular vertical body with an upper and lower portion, a generally U-shaped lower portion extending in a first direction from said vertical body, and a generally right triangle shaped upper portion of which the back of said right triangle shape is parallel to said vertical body and the base of said right triangle shape is perpendicular to and extending in a second and opposite direction from said vertical body. The back of said right triangle shape is fastened to the vertical body for added strength and a suction cup or other device is attached to the window side of the upper portion of said vertical body to keep said vertical body in a vertical position when the window is closed.

In accordance with a second embodiment of the invention, there is disclosed an article of manufacture for securing a window in a partial open position comprising: a flat rigid strip of material having a rectangular vertical body with an upper and lower portion, a generally U-shaped lower portion extending in a first direction from said vertical body, and a generally square shaped upper portion of which the back of said square shape is parallel to said vertical body and the base of said square shape is perpendicular to and extending in a second and opposite direction from said vertical body. The back of said square shape is fastened to the vertical body for added strength and a suction cup or other device is attached to the window side of the upper portion of said vertical body to keep said vertical body in a vertical position when the window is closed.

In accordance with a third embodiment of the invention, there is disclosed an article of manufacture for securing a window in a partial open position comprising: a flat rigid strip of material having a rectangular vertical body with an upper and lower portion, a generally U-shaped lower portion extending in a first direction from said vertical body, and a generally inverted U-shaped upper portion extending in a second and opposite direction from said vertical body with the inverted U-shape opening wide enough to accommodate the reception of the window sash when said window is opened. A suction cup or other device is attached to the window side of the upper portion of said vertical body to keep said vertical body in a vertical position when the window is closed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the preferred embodiment of the invention.

FIG. 2 is the side view of the preferred embodiment of the invention.

FIG. 3 is a view of the invention installed on a window.

FIG. 4 is a side view of the invention in operation on an open window.

FIG. 5 is a side view of the invention on a closed window.

FIG. 6 is an enlarged view of the invention in operation on an open window.

FIG. 7 is a perspective view of the second embodiment.

FIG. 8 is a perspective view of a third embodiment.

FIG. 9 is a side view of the second embodiment in operation.

FIG. 10 is a side view of the third embodiment in operation.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

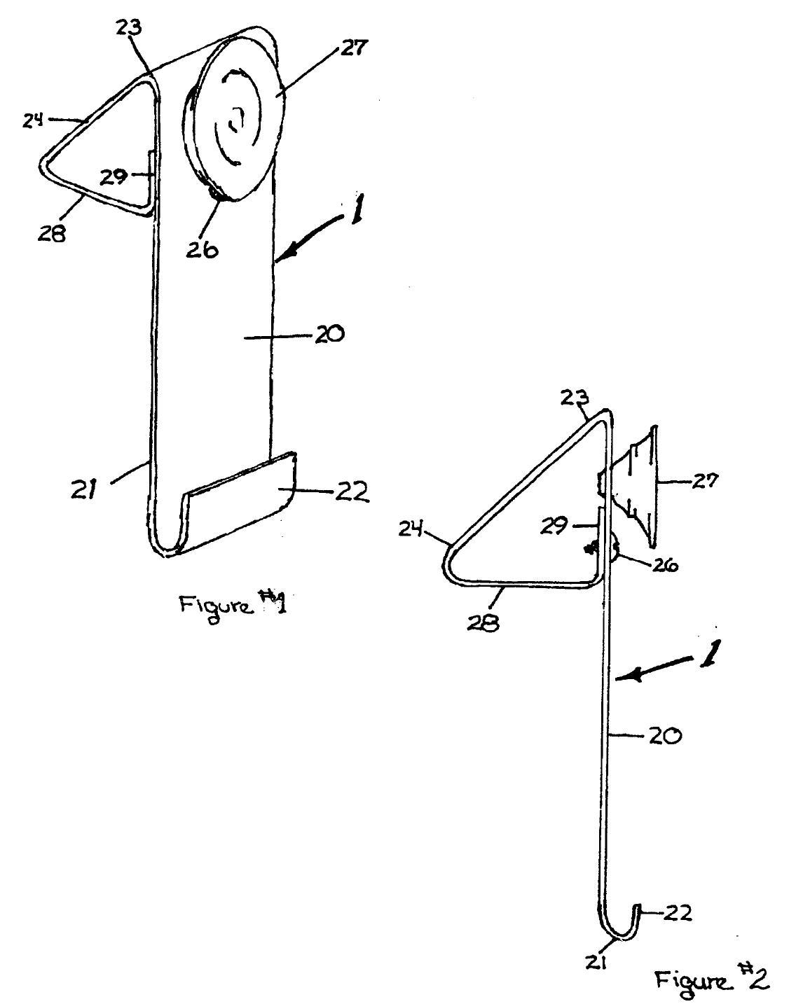

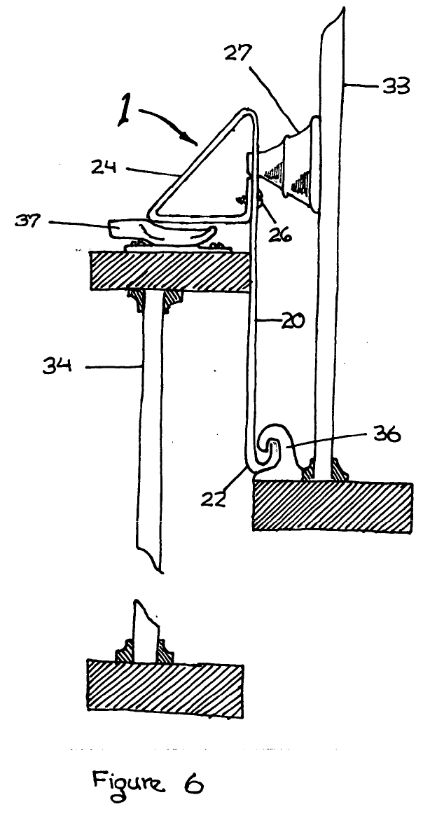

Referring to the drawings, FIG. 1 shows a perspective view of the preferred embodiment of the partial open window stop 1. The device includes a flat rigid strip of material having a rectangular vertical body 20 with a lower portion 21 and an upper portion 23. The lower portion 21, is generally U-shaped 22 and extends in a first direction from the vertical body 20. The generally U-Shaped 22 lower portion 21 serves to interact with the windows own locking mechanism receiver 36 usually mounted on the upper window sash 33 as shown in FIG. 6. The upper portion 23 is a generally right triangle shape 24 of which the back 29 of the right triangle shape 24 is parallel to the vertical body 20 and the base 28 of the right triangle shape 24 is perpendicular to and extending in a second and opposite direction from the vertical body 20. The right triangle shaped 24 upper portion 23 serves to interrupt the path of the opposite window sash 34 to which the partial open window stop 1 is mounted as seen in FIG. 4. The back 29 of the right triangle shape 24 is attached to the vertical body 20 for added strength by using a fastener 26 or means of fastening. A suction cup 27 or other device is attached to the window side of the upper portion 23 of the vertical body 20 only to keep the partial open window stop 1 in a vertical position when the window is closed.

FIG. 2 shows a side view of the preferred embodiment of the partial open window stop 1. This view clarifies the generally U-shaped 22 lower portion 21 extending in a first direction from the vertical body 20 and the generally right triangle shape 24 upper portion 23 extending in a second and opposite direction from the vertical body 20 with the base 28 of the right triangle shape 24 perpendicular to the vertical body 20 and the back 29 of the right triangle shape 24 parallel to the vertical body 20. It also shows ideal placement of the suction cup 27 or other device used to keep the invention in a vertical position when the window is closed. A fastener 26 or means of fastening is used to secure the back 29 of the right triangle shape 24 to the vertical body 20 for added strength.

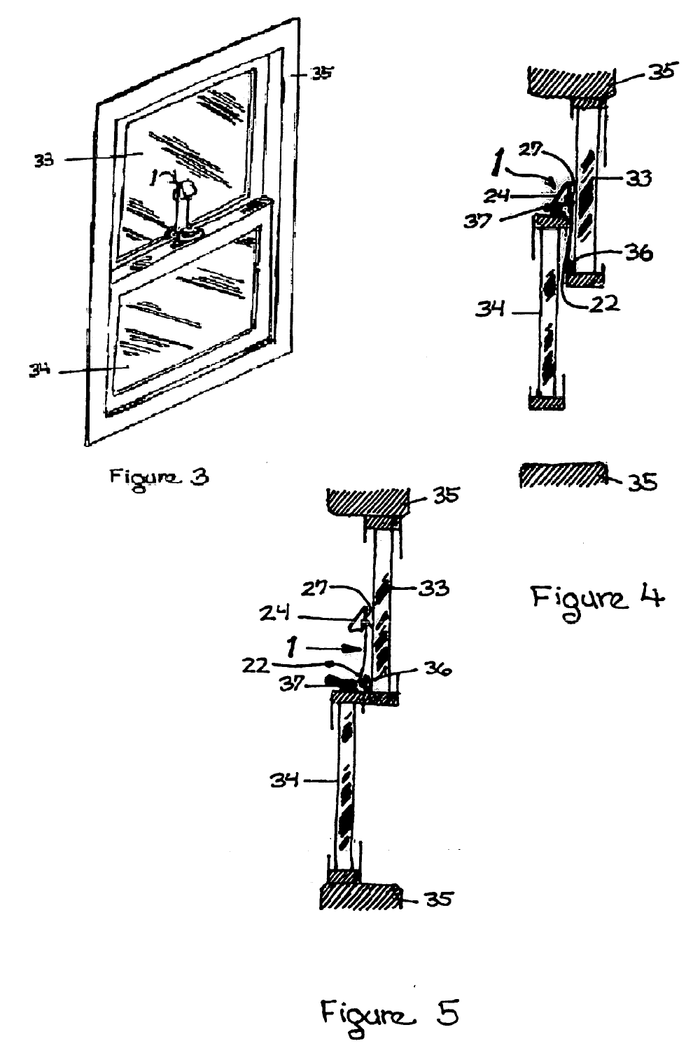

Turning to FIG. 3, a front view of the partial open window stop 1 installed on the inside of a typical window. FIG. 4 shows an enlarged view of the preferred embodiment of the invention in operation between windows 33 and 34 mounted within window frame 35. The U-shaped 22 lower portion 21 interacts with the windows lock receiver 36 mounted to the upper window sash 33 after the windows locking mechanism 37 mounted to the lower sash 34 has been disengaged. The right triangle shape 24 upper portion 23 interrupts the path of travel of the opposite window 34 to which it is attached. The window will travel only the same distance as the vertical body 20 is long. The right triangle shape 24 upper portion 23 is on the inside of the house. The fastener 26 or means of fastening the back 29 of the right triangle shape 24 to the vertical body 20 adds strength to the right triangle shape 24 and even with substantial vertical force on either window 33 or 34, it is unlikely that the security of this window will be compromised due to the failure of this invention. As can be seen, this device leaves no parts exposed to the outside of the window which lessens the likelihood of tampering from an intruder. FIG. 5 shows the device 1 as left when the window is closed. The suction cup 27 or other device attached to the window side of the upper portion 23 adheres to the window 33 so that when the window is closed, the device will stay in its vertical position.

A close up view of the interaction between the generally U-shaped 22 lower portion 21 and the windows lock receiver 36 attached to the upper window 33 sash can be seen in FIG. 6. Also seen is the suction cup 27 adhered to the upper window 33 and the right triangle shaped 24 upper portion 23 interrupting the path of the lower window 34 by coming to rest on the windows locking mechanism 37.

To install the partial open window stop 1, simply disengage the windows locking mechanism 37, horizontally slide the U-shape 22 lower portion 21 into the windows locking mechanism receiver 36 and adhere the suction cup 27 to the window. The preferred embodiment of the partial open window stop 1 is made from a sufficiently thin strong metal material that will not bend or fracture when in use and substantial vertical force is applied to either window 33 or 34. The material of which the device is made shall not be limited to metal. Any sufficiently strong thin material may be used.

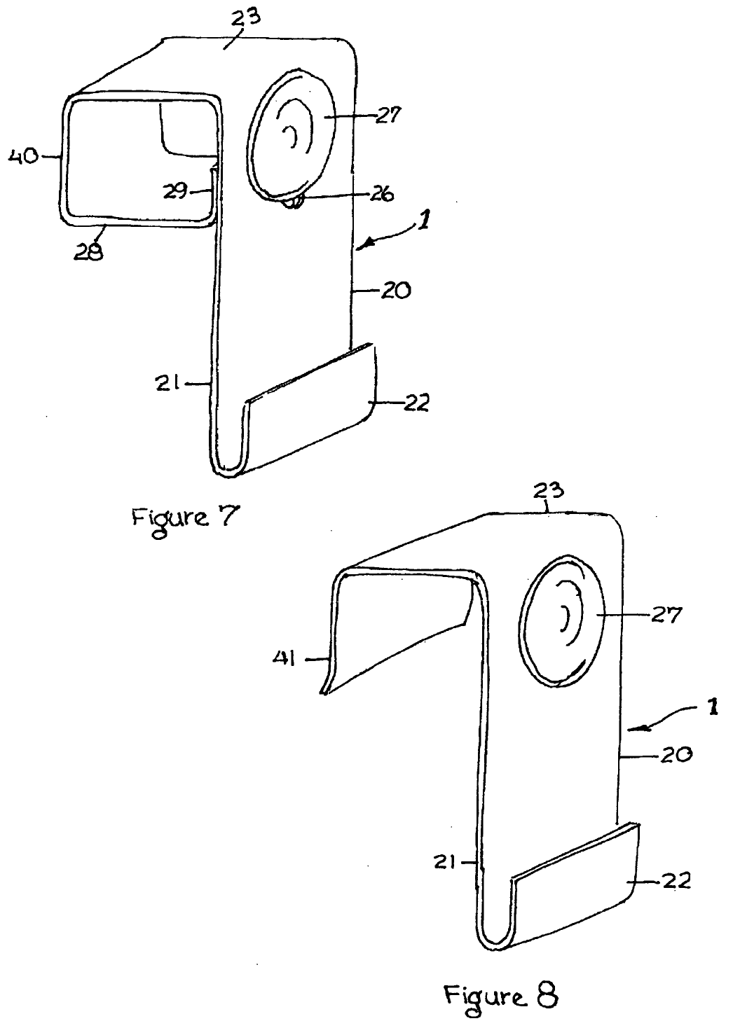

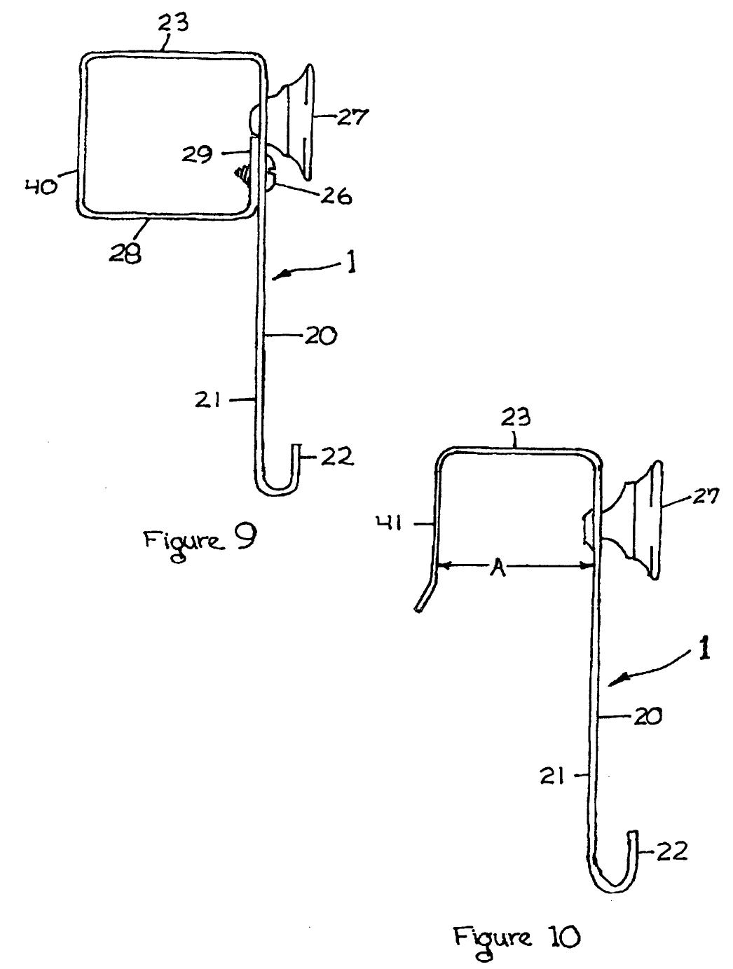

FIG. 7 shows a perspective view of a second embodiment of the invention. Instead of a generally right triangle shape 24 upper portion 23, this embodiment uses a generally square shape 40 upper portion 23. Otherwise it functions in the same manner as described above. FIG. 9 is a side view of the second embodiment of the invention.

FIG. 8 shows a perspective view of a third embodiment of the invention. It is different in that the upper portion 23 is an inverted U shape 41 which is meant to accommodate the reception of the opposite window sash to which is mounted. The width of the inverted U shape 41 labeled A in FIG. 10 may be variable to accommodate the varying widths of window sashes from different window manufactures. FIG. 10 shows a side view of the third embodiment.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An article of manufacture for securing a window in a partial open position comprising:
a flat rigid strip of material having a rectangular vertical body with an upper and lower portion;
a generally U-shaped lower portion extending in a first direction from said vertical body; and
a generally right triangle shaped upper portion of which the back of said right triangle shape is parallel to said vertical body and the base of said right triangle shape is perpendicular to and extending in a second and opposite direction from said vertical body.

2. An article of manufacture for securing a window in a partial open position as claimed in claim 1 wherein the back of said right triangle shape is fastened to the vertical body for added strength.

3. An article of manufacture for securing a window in a partial open position as claimed in claim 1 wherein a suction cup or other device is attached to the window side of the upper portion of said vertical body to keep said vertical body in a vertical position when the window is closed.

4. An article of manufacture for securing a window in a partial open position as claimed in claim 1 wherein a coating is applied for aesthetic purposes and to protect the window sash from damage.

5. An article of manufacture for securing a window in a partial open position comprising:
a flat rigid strip of material having a rectangular vertical body with an upper and lower portion;
a generally U-shaped lower portion extending in a first direction from said vertical body; and
a generally square shaped upper portion of which the back of said square shape is parallel to said vertical body and the base of said square shape is perpendicular to and extending in a second and opposite direction from said vertical body.

6. An article of manufacture for securing a window in a partial open position as claimed in claim 5 wherein the back of said square shape is fastened to the vertical body for added strength.

7. An article of manufacture for securing a window in a partial open position as claimed in claim 5 wherein a suction cup or other device is attached to the window side of the upper portion of said vertical body to keep said vertical body in a vertical position when the window is closed.

8. An article of manufacture for securing a window in a partial open position as claimed in claim 5 wherein a coating is applied for aesthetic purposes and to protect the window sash from damage.

9. An article of manufacture for securing a window in a partial open position comprising:
a flat rigid strip of material having a rectangular vertical body with an upper and lower portion;
a generally U-shaped lower portion extending in a first direction from said vertical body; and
a generally inverted U-shaped upper portion extending in a second and opposite direction from said vertical body with the inverted U-shape opening wide enough to accommodate the reception of the window sash when said window is opened.

10. An article of manufacture for securing a window in a partial open position as claimed in claim 9 wherein a suction cup or other device is attached to the window side of the upper portion of said vertical body to keep said vertical body in a vertical position when the window is closed.

11. An article of manufacture for securing a window in a partial open position as claimed in claim 9 wherein a coating is applied for aesthetic purposes and to protect the window sash from damage.
